(19) United States
(12) Patent Application Publication
(10) Pub. No.: US 2022/0138372 A1
(43) Pub. Date: May 5, 2022

(54) SYSTEM AND METHOD FOR DESIGNING MEMS MIRROR BASED ON COMPUTED QUALITY FACTOR

(71) Applicant: BEIJING VOYAGER TECHNOLOGY CO., LTD., Beijing (CN)

(72) Inventors: Youmin Wang, Mountain View, CA (US); Yufeng Wang, Mountain View, CA (US); Gary Li, Mountain View, CA (US)

(73) Assignee: BEIJING VOYAGER TECHNOLOGY CO., LTD., Beijing (CN)

(21) Appl. No.: 17/092,207

(22) Filed: Nov. 6, 2020

Related U.S. Application Data
(63) Continuation-in-part of application No. 17/090,788, filed on Nov. 5, 2020.

(51) Int. Cl. G06F 30/20; G02B 27/00

(52) U.S. Cl. CPC G06F 30/20; G02B 26/105; G02B 27/0012

(57) ABSTRACT

Embodiments of the disclosure provide a method for designing an optical scanning mirror. The method may include receiving, by a communication interface, a set of initial design parameters of the scanning mirror. The method may also include computing an initial quality factor associated with the scanning mirror, by at least one processor, based on the initial design parameters. The method may further include determining, by the at least one processor, at least one structural alteration associated with the scanning mirror based on a comparison between the initial quality factor and a target quality factor. The method may also include outputting, by the at least one processor, the at least one structural alteration to be implemented on the scanning mirror.

### CROSS-REFERENCE TO RELATED APPLICATION(S)

This application is a continuation-in-part of U.S. application Ser. No. 17/090,788, entitled “SYSTEMS AND METHOD FOR COMPUTING QUALITY FACTOR OF MEMS MIRROR” and filed on Nov. 5, 2020, which is expressly incorporated by reference herein in its entirety.

### TECHNICAL FIELD

The present disclosure relates to designing scanning mirrors used in optical sensing systems, and more particularly to, a method for adjusting a quality factor (Qₜₒₜₐₗ) associated with a scanning mirror by including at least one structural alteration to the scanning mirror assembly during the design phase.

### BACKGROUND

Optical sensing systems, e.g., such as LiDAR systems, have been widely used in advanced navigation technologies, such as to aid autonomous driving or to generate high-definition maps. For example, a typical LiDAR system measures the distance to a target by illuminating the target with pulsed laser light beams and measuring the reflected pulses with a sensor. Differences in laser light return times, wavelengths, and/or phases can then be used to construct digital three-dimensional (3D) representations of the target. Because using a narrow laser beam as the incident light can map physical features with very high resolution, a LiDAR system is particularly suitable for applications such as sensing in autonomous driving and high-definition map surveys.

The LiDAR system may include a transmitter configured to emit a light beam to scan an object and a receiver configured to receive the light beam reflected by the object. The transmitter and the receiver may use optical components (e.g., a scanning mirror) to steer the light beam to a range of directions. A scanning mirror can be a single micro mirror, or an array of micro mirrors integrated into a micromachined mirror assembly made from semiconductor materials such as using microelectromechanical system (MEMS) technologies. In certain applications, a MEMS mirror may be operated at or near resonance. Using resonance may enable optical sensing systems to obtain large mirror deflection angles in a relatively small amount of time as compared to a non-resonating mirror. MEMS mirrors resonate at or near their characteristic oscillation frequencies, which are determined by their dimensions, e.g., such as their mass, structure, and spring constant, just to name a few.

The quality factor, (hereinafter, Q-factor), is a dimensionless parameter that describes the underdamping of a scanning mirror and may be used to estimate the maximum scanning angle of the MEMS mirror. Hence, being able to compute the Q-factor accurately and efficiently during the design phase of a MEMS mirror may be beneficial. Currently available techniques for computing the Q-factor during the design phase of a MEMS mirror requires an undesirable amount of time and computational resources, which makes these techniques difficult or impractical. Because of the inefficiency in computing the Q-factor, it is also not feasible to use Q-factor as the guide the design changes of the MEMS mirror using the conventional methods.

Embodiments of the disclosure address the above problems by providing a method for computing the Q-factor that may use a reduced amount of time and computational resources as compared to the currently available techniques and a method for designing the MEMS mirror based on such computed Q-factor.

### SUMMARY

Embodiments of the disclosure provide a method for designing an optical scanning mirror. The method may include receiving, by a communication interface, a set of initial design parameters of the scanning mirror. The method may also include computing an initial quality factor associated with the scanning mirror, by at least one processor, based on the initial design parameters. The method may further include determining, by the at least one processor, at least one structural alteration associated with the scanning mirror based on a comparison between the initial quality factor and a target quality factor. The method may also include outputting, by the at least one processor, the at least one structural alteration to be implemented on the scanning mirror.

Embodiments of the disclosure also provide a system for designing an optical scanning mirror. The system may include a communication interface configured to receive a set of initial design parameters of the scanning mirror. The system may further include at least one processor. The at least one processor may be configured to compute an initial quality factor associated with the scanning mirror based on the initial design parameters. The at least one processor may be also configured to determine at least one structural alteration associated with the scanning mirror based on a comparison between the initial quality factor and a target quality factor. The at least one processor may be also configured to output the at least one structural alteration to be implemented on the scanning mirror.

Embodiments of the disclosure further provide a non-transitory computer readable medium having instructions stored thereon that, when executed by one or more processors, causes the one or more processors to perform a method for designing an optical scanning mirror. The method may include receiving a set of initial design parameters of the scanning mirror. The method may also include computing an initial quality factor associated with the scanning mirror based on the initial design parameters. The method may further include determining at least one structural alteration associated with the scanning mirror based on a comparison between the initial quality factor and a target quality factor. The method may also include outputting the at least one structural alteration to be implemented on the scanning mirror.

Embodiments of the disclosure provide a method for designing an optical scanning mirror. The method may include receiving, by a communication interface, a set of initial design parameters and a set of adjusted design parameters of the scanning mirror, the set of adjusted design parameters reflecting design alterations not reflected by the set of initial design parameters. In some embodiments, the set of adjusted design parameters may include one or more of holes formed in the scanning mirror, a gimbal of the scanning mirror assembly. In some other embodiments, the set of the adjusted design parameters may include one or more air dams formed adjacent to the scanning mirror. The method may further include computing an initial quality factor of the scanning mirror, by at least one processor, based on the set of initial design parameters. The method may also include computing an adjusted quality factor of the scanning mirror, by the at least one processor, based on the set of adjusted design parameters. Computing each of the initial quality factor and the adjusted quality factor includes computing a first quality factor associated with slide film damping of the scanning mirror and a second quality factor associated with squeeze film damping of the scanning mirror. The method may include outputting, by the at least one processor, the initial quality factor and the adjusted quality factor associated with the scanning mirror.

Embodiments of the disclosure also provide a system for designing an optical scanning mirror. The system may include a communication interface configured to receive a set of initial design parameters and a set of adjusted design parameters of the scanning mirror, the set of adjusted design parameters reflecting design alterations not reflected by the set of initial design parameters. In some embodiments, the set of adjusted design parameters may include one or more of holes formed in the scanning mirror and/or a gimbal of the scanning mirror assembly. In some other embodiments, the set of the adjusted design parameters may include one or more air dams formed adjacent to the scanning mirror. The system may further include at least one processor. The at least one processor may be configured to compute an initial quality factor of the scanning mirror, by at least one processor, based on the set of initial design parameters. The at least one processor may also be configured to compute an adjusted quality factor of the scanning mirror, by the at least one processor, based on the set of adjusted design parameters. In certain implementations, the at least one processor may be configured to compute each of the initial quality factor and the adjusted quality factor by computing a first quality factor associated with slide film damping of the scanning mirror and a second quality factor associated with squeeze film damping of the scanning mirror. The at least one processor may be further configured to output the initial quality factor and the adjusted quality factor associated with the scanning mirror.

Embodiments of the disclosure further provide a non-transitory computer readable medium having instructions stored thereon that, when executed by one or more processors, causes the one or more processors to perform a method for designing an optical scanning mirror. The method may include receiving a set of initial design parameters and a set of adjusted design parameters of the scanning mirror, the set of adjusted design parameters reflecting design alterations not reflected by the set of initial design parameters. In some embodiments, the set of adjusted design parameters may include one or more of holes formed in the scanning mirror and/or a gimbal of the scanning mirror assembly. In some other embodiments, the set of the adjusted design parameters may include one or more air dams formed adjacent to the scanning mirror. The method may further include computing an initial quality factor of the scanning mirror based on the set of initial design parameters. The method may also include computing an adjusted quality factor of the scanning mirror based on the set of adjusted design parameters. Computing each of the initial quality factor and the adjusted quality factor includes computing a first quality factor associated with slide film damping of the scanning mirror and a second quality factor associated with squeeze film damping of the scanning mirror. The method may include outputting the initial quality factor and the adjusted quality factor associated with the scanning mirror.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a block diagram of an exemplary LiDAR system, according to embodiments of the disclosure.

FIG. 2A illustrates a top view of an exemplary scanning mirror design, according to embodiments of the disclosure.

FIG. 2B illustrates a top view of another exemplary scanning mirror design, according to embodiments of the disclosure.

FIG. 3 illustrates a data flow for computing a Q-factor associated with squeeze film damping, according to embodiments of the disclosure, according to embodiments of the disclosure.

FIG. 4A illustrates a first parametric model associated with a scanning mirror assembly, according to embodiments of the disclosure.

FIG. 4B illustrates a second parametric model associated with a scanning mirror assembly, according to embodiments of the disclosure.

FIG. 4C illustrates a third parametric model associated with a scanning mirror assembly, according to embodiments of the disclosure.

FIG. 4D illustrates a fourth parametric model associated with air surrounding the scanning mirror assembly, according to embodiments of the disclosure.

FIG. 5 illustrates interfaces between air and a scanning mirror assembly, according to embodiments of the disclosure.

FIG. 6A illustrates a closed air boundary associated with a scanning mirror assembly, according to embodiments of the disclosure.

FIG. 6B illustrates an open air boundary associated with a scanning mirror assembly, according to embodiments of the disclosure.

FIG. 7 illustrates a block diagram of an exemplary system for designing a scanning mirror, according to embodiments of the disclosure.

FIG. 8 illustrates a flow chart of an exemplary method for designing a scanning mirror, according to embodiments of the disclosure.

FIG. 9 illustrates a data flow diagram of an exemplary system for designing a scanning mirror, according to embodiments of the disclosure.

FIG. 10 illustrates a flow chart of another exemplary method for designing a scanning mirror, according to embodiments of the disclosure.

FIG. 11 illustrates a data flow diagram of another exemplary system for designing a scanning mirror, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

The scanning mirror is one part of an optical scanning systems. The scanning mirror performance directly affects the accuracy of point cloud and the image generated using the optical scanning system. One of the design parameters related to the scanning mirror performance is quality factor, (hereinafter, Q-factor). The Q-factor is related to the harmonic motion of a resonator, e.g., such as a resonating scanning mirror. More specifically, the Q-factor describes the underdamping, which is the energy dissipation (e.g., ΔE) with respect to time, of the scanning mirror.

The scanning angle, and, hence, the performance of the scanning mirror is directly affected by the Q-factor. For example, the maximum scanning angle of the scanning mirror at the resonant frequency θᵣ, can be estimated using Equation (1) below, where θₛ is the non-resonant scanning angle and Q is the Q-factor.

θᵣ≈Q·θₛ (1)

An example Q-factor range may be 100-1000. In some embodiments, a scanning mirror designed with a Q-factor of 525 may be desirable. While, in some other embodiments, a scanning mirror designed with a Q-factor of 725 may be desirable. Accordingly, being able to calculate the Q-factor with a high degree of accuracy and efficiency during the design phase for a scanning mirror may be crucial.

In a damping-free system, the Q-factor of a resonator is infinity. In a vacuum environment in which the scanning mirror does not experience much damping, the Q-factor may be defined as the ratio of the scanning mirror's center frequency f₀ to its bandwidth Δf, as given by Equation (2) below:

$$Q = \frac{{f}_{0}}{Δ f} \qquad ( 2 )$$

However, the Q-factor calculation, for a scanning mirror in a non-vacuum environment, must take into consideration the effects of damping on harmonic motion if a high degree of accuracy is to be achieved.

Damping may occur when the freely moving scanning mirror is separated from the underlying substrate by a thin layer of air. When the scanning mirror resonates, flow occurs in the thin layer of air and the resulting energy dissipation produces damping. When the scanning mirror is driven using drive comb fingers, flow may also occur in the gaps between the drive comb fingers and the mirror, which may also cause damping. The damping of the scanning mirror includes both squeeze film damping and slide film damping.

In squeeze film damping, the scanning mirror moves so that the gap between scanning mirror and the substrate expands and/or contracts. When the gap contracts, the air film is squeezed between the scanning mirror and the substrate. In slide film damping, the scanning mirror moves parallel to structures such as drive comb fingers, leading to shearing within the air film. By dissipating energy from the moving scanning mirror, the air film results in a damping effect in both instances of squeeze and slide film damping. Squeeze film damping and slide film damping affect the harmonic motion of a scanning mirror, and, hence, they also affect the Q-factor of the scanning mirror.

For example, the governing equation of motion for a rigid body, e.g., such as a scanning mirror, is set forth below in Equation (3), where θ is mirror angle, J is mirror rotational moment of inertia, c_{squeeze} is damping coefficient primarily due to squeeze film effect from mirror, c_{slide} is damping coefficient primarily due to slide film effect from the drive combs, k is rotation spring constant, and M(t) is drive torque:

$$J \frac{{\partial }^{2} θ}{\partial {t}^{2}} + ( {c}_{squeeze} + {c}_{slide} ) \frac{\partial θ}{\partial t} + k θ = M ( t ) \qquad ( 3 )$$

The c_{squeeze} and c_{slide} may be used to compute, among other things, the Q-factor for the scanning mirror. Currently available techniques for solving c_{squeeze} and c_{slide} using Equation (3) involve a simulation model, e.g., such as a computational fluid dynamics (CFD) model. In certain implementations, c_{slide} may be associated with the drive comb fingers, and c_{squeeze} may be associated with the up-down motion of a scanning mirror. The simulation model may simulate, e.g., the motion of a resonating scanning mirror assembly (e.g., scanning mirror, drive comb(s), anchor, torsion spring, substrate, etc.) and the air fluidity within the system. In order to solve the Navier-Stokes equations, which are a set of partial differential equations which describe the motion of air fluidity, the simulation model may use, e.g., a finite element analysis (FEA) method.

The FEA method subdivides the scanning mirror assembly (e.g., the scanning mirror, drive comb, anchors, substrate, etc.) into smaller, simpler parts, e.g., that are called finite elements. The subdivision of the scanning mirror system may be achieved by a particular space discretization in the space dimensions, which may be implemented by the construction of a mesh of the scanning mirror system: the numerical domain for the solution, which has a finite number of points.

For a scanning mirror assembly, due to the large scanning mirror size compared to the narrow air gaps associated with the drive comb fingers, different sized meshes may be used to simulating the fluidity in these different areas. For example, the narrow air gaps of the drive comb fingers may need a mesh with a higher resolution, and, hence, use a mesh with smaller finite element sizes. On the other hand, the scanning mirror mesh may be of lower resolution, i.e., finite elements of a larger size, in order to keep the simulation model from crashing due to the size of the scanning mirror in the overall simulation. The discrepancy in mesh resolutions between the mirror and drive comb areas poses computational challenges to the simulation.

Merging the drive comb mesh (e.g., first mesh with finite elements of a first size) with the scanning mirror mesh (e.g., second mesh with finite elements of a second size) may lead to crashes in simulation. For example, even if the scanning mirror mesh and the drive comb mesh can be merged together in the simulation model, the simulation may abort due to an inadequate mix and match of the drive comb mesh with finite elements of a first size and the scanning mirror mesh with finite elements of a second size. Therefore, computing c_{squeeze} and c_{slide}, and, hence, the Q-factor using the currently available techniques may be difficult or impractical.

The present disclosure provides a solution by separately adjusting a quality factor (Qₜₒₜₐₗ) associated with a scanning mirror by including at least one structural alteration to the scanning mirror assembly during the design phase. The techniques provided herein may use significantly less time and computational resources in order to adjust the Q-factor associated with a scanning mirror design as compared to the currently available techniques.

Some exemplary embodiments are described below with reference to MEMS mirror(s) used in LiDAR system(s), but the techniques for computing the Q-factor are not limited thereto. Rather, one of ordinary skill would understand that the following description, embodiments, and techniques may apply to any type of scanning mirror and/or optical sensing system (e.g., biomedical imaging, 3D scanning, tracking and targeting, free-space optical communications (FSOC), and telecommunications, just to name a few) known in the art without departing from the scope of the present disclosure.

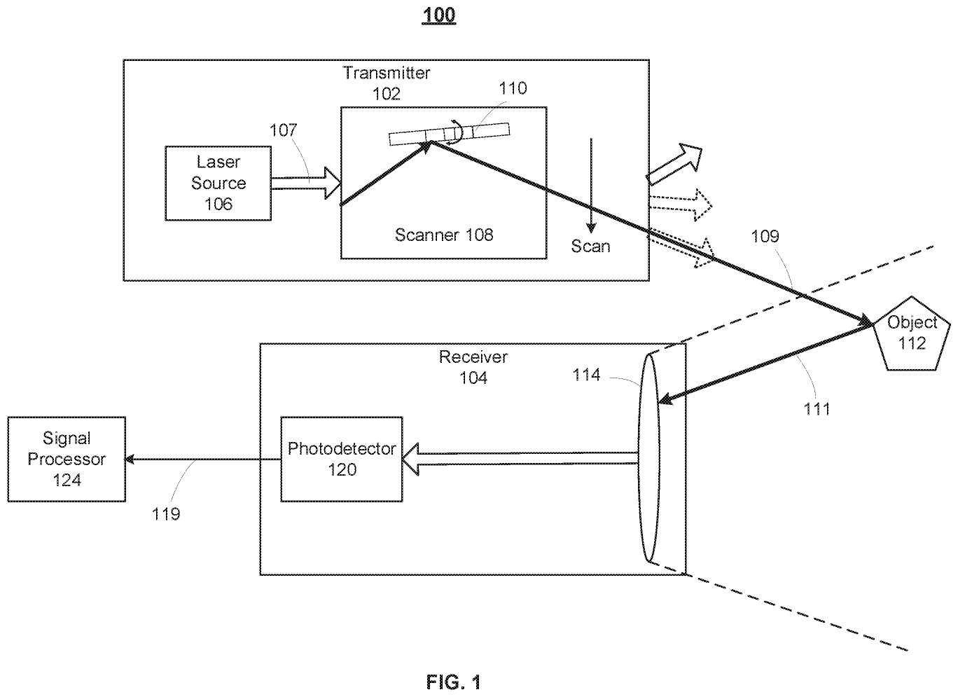

FIG. 1 illustrates a block diagram of an exemplary LiDAR system 100, according to embodiments of the disclosure. LiDAR system 100 may include a transmitter 102 and a receiver 104. Transmitter 102 may emit laser beams along multiple directions. Transmitter 102 may include one or more laser sources 106 and a scanner 108.

Transmitter 102 can sequentially emit a stream of pulsed laser beams in different directions within a scan range (e.g., a range in angular degrees), as illustrated in FIG. 1. Laser source 106 may be configured to provide a laser beam 107 (also referred to as “native laser beam”) to scanner 108. In some embodiments of the present disclosure, laser source 106 may generate a pulsed laser beam in the ultraviolet, visible, or near infrared wavelength range.

In some embodiments of the present disclosure, laser source 106 may include a pulsed laser diode (PLD), a vertical-cavity surface-emitting laser (VCSEL), a fiber laser, etc. For example, a PLD may be a semiconductor device similar to a light-emitting diode (LED) in which the laser beam is created at the diode's junction. In some embodiments of the present disclosure, a PLD includes a PIN diode in which the active region is in the intrinsic (I) region, and the carriers (electrons and holes) are pumped into the active region from the N and P regions, respectively. Depending on the semiconductor materials, the wavelength of incident laser beam 107 provided by a PLD may be smaller than 1,100 nm, such as 405 nm, between 445 nm and 465 nm, between 510 nm and 525 nm, 532 nm, 635 nm, between 650 nm and 660 nm, 670 nm, 760 nm, 785 nm, 808 nm, 848 nm, or 905 nm. It is understood that any suitable laser source may be used as laser source 106 for emitting laser beam 107.

Scanner 108 may be configured to emit a laser beam 109 to an object 112 in a direction within a range of scanning angles. In some embodiments consistent with the present disclosure, scanner 108 may include a micromachined mirror assembly having a scanning mirror, such as MEMS mirror 110. In some embodiments, at each time point during the scan, scanner 108 may emit laser beam 109 to object 112 in a direction within a range of scanning angles by rotating the micromachined mirror assembly. MEMS mirror 110, at its rotated angle, may deflect the laser beam 107 generated by laser sources 106 to the desired direction, which becomes laser beam 109. The micromachined mirror assembly may include various components that enable, among other things, the rotation of the MEMS mirror 110. For example, the micromachined mirror assembly may include, among other things, a scanning mirror (e.g., MEMS mirror 110), a first set of anchors, one or more actuators each coupled to an anchor in the first set of anchors, a second set of anchors, at least one spring coupled to at least one anchor in the set of anchors, and a substrate, just to name a few.

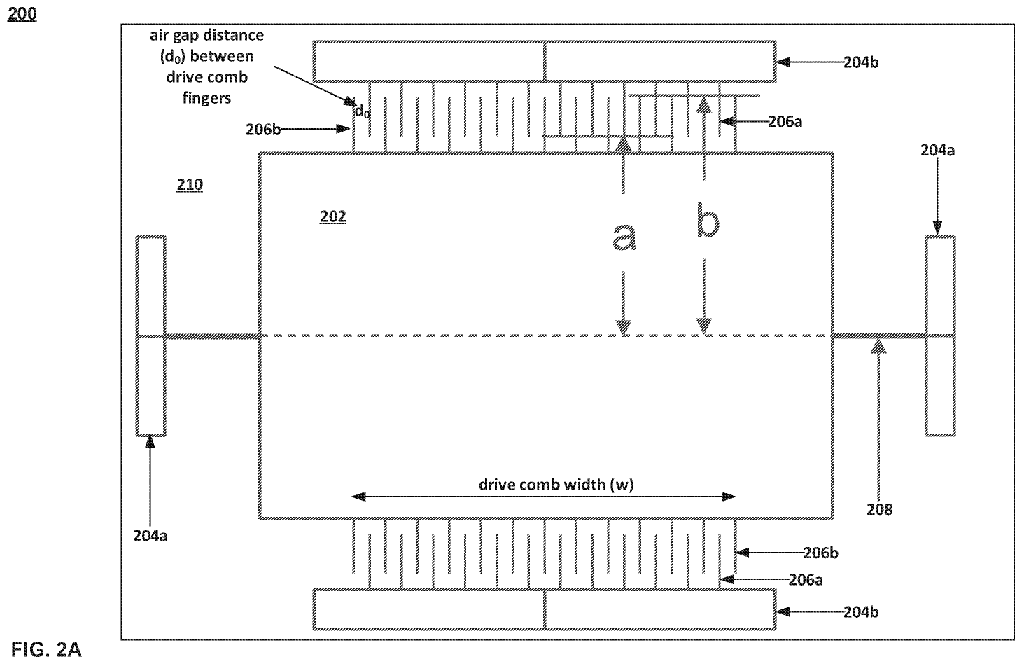

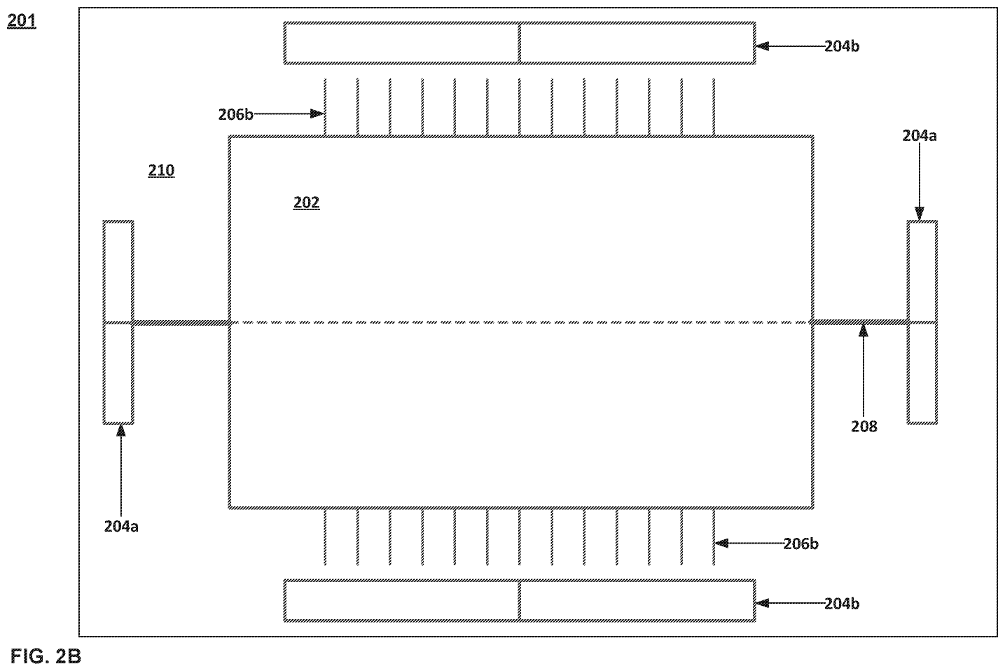

Certain design parameters of the MEMS mirror 110 may impact its scanning field of view (FOV). One such design parameter, as mentioned above, is the Q-factor. The Q-factor is proportional to the maximum scanning angle of a MEMS mirror 110. Thus, it may be beneficial to design a MEMS mirror with a Q-factor that may be tailored to a desired scanning FOV. The present disclosure provides a method that may enable a user to adjust a scanning mirror design based on accurately and efficiently computing the Q-factor during the design phase of a MEMS mirror 110 in order to meet specific, e.g., LiDAR system requirements. For example, the method may determine appropriate design alterations based on a comparison of the computed Q-factor and a target Q-factor. Additional details associated with computing the Q-factor and making design alterations accordingly are set forth below in connection with FIGS. 2-11.

Object 112 may be made of a wide range of materials including, for example, non-metallic objects, rocks, rain, chemical compounds, aerosols, clouds and even single molecules. In some embodiments of the present disclosure, scanner 108 may also include optical components (e.g., lenses) that can focus pulsed laser light into a narrow laser beam to increase the scan resolution.

In some embodiments, receiver 104 may be configured to detect a returned laser beam 111 returned from object 112. The returned laser beam 111 may be in a different direction from laser beam 109. Receiver 104 can collect laser beams returned from object 112 and output electrical signals reflecting the intensity of the returned laser beams. Upon contact, laser light can be reflected by object 112 via backscattering, such as Rayleigh scattering, Mie scattering, Raman scattering, and fluorescence. As illustrated in FIG. 1, receiver 104 may include a lens 114 and a photodetector 120. Lens 114 may be configured to collect light from a respective direction in its FOV and converge the laser beam to focus before it is received on photodetector 120. At each time point during the scan, returned laser beam 111 may be collected by lens 114. Returned laser beam 111 may be returned from object 112 and have the same wavelength as laser beam 109.

Photodetector 120 may be configured to detect returned laser beam 111 returned from object 112. In some embodiments, photodetector 120 may convert the laser light (e.g., returned laser beam 111) collected by lens 114 into an electrical signal 119 (e.g., a current or a voltage signal). Electrical signal 119 may be generated when photons are absorbed in a photodiode included in photodetector 120. In some embodiments of the present disclosure, photodetector 120 may include a PIN detector, a PIN detector array, an avalanche photodiode (APD) detector, a APD detector array, a single photon avalanche diode (SPAD) detector, a SPAD detector array, a silicon photo multiplier (SiPM/MPCC) detector, a SiP/MPCC detector array, or the like.

LiDAR system 100 may also include one or more signal processor 124. Signal processor 124 may receive electrical signal 119 generated by photodetector 120. Signal processor 124 may process electrical signal 119 to determine, for example, distance information carried by electrical signal 119. Signal processor 124 may construct a point cloud based on the processed information. Signal processor 124 may include a microprocessor, a microcontroller, a central processing unit (CPU), a graphical processing unit (GPU), a digital signal processor (DSP), or other suitable data processing devices.

FIG. 2A illustrates a top view of an exemplary scanning mirror design 200, according to embodiments of the disclosure. Various aspects of the scanning mirror design 200 may be used (e.g., during the design phase) to calculate the slide film damping Q-factor (Q_{slide}) of a scanning mirror 202 (e.g., MEMS mirror 110).

For example, the scanning mirror design 200 may include a first set of design parameters that may be used to calculate Q_{slide}. In some embodiments, the first set of design parameters may be associated with one or more components of a scanning mirror assembly that would affect the slide film damping of the mirror. For example, the one or more components of the scanning mirror assembly affecting slide film damping may include, but are not limited to, a scanning mirror 202 (e.g., MEMS mirror 110), a first set of anchors 204a, a second set of anchors 204b, fixed drive comb fingers 206a coupled to anchors 204b, sliding drive comb fingers 206b coupled to the scanning mirror 202, a torsion spring 208, and/or a substrate 210, just to name a few.

In some embodiments, the first set of design parameters may be parameters of these components, and any change to these parameters may affect the slide film damping Q-factor. For example, the first set of design parameters may include dimensions (e.g., length, width, and thickness) of above components, e.g., dimensions of the scanning mirror 202 and dimensions of the drive comb, and distances between these components, e.g., the distance between the scanning mirror 202 and the anchors 204b. Other examples of the first set of design parameters may include one or more of the materials of these components, the natural frequency of the scanning mirror 202, air density, total overlap area for all drive comb fingers 206a, 206b, air gap spacing between components (e.g., the air gap between fixed drive comb fingers 206a and the sliding drive comb fingers 206b), ambient pressure, operation frequency, air density, silicon density, moment of inertia of the scanning mirror, just to name a few.

In some embodiments, the slide film damping quality factor (Q_{slide}) associated with scanning mirror 202 may be calculated using the first set of design parameters and a first set of computations, e.g., Equations (4)-(7) set forth below. As illustrated in FIG. 2A, the aspect ratio of drive comb thickness (e.g., depth from the top of the drive comb to the substrate 210) over the drive comb air gap (n) may be greater than 10. Therefore, the slide film damping (e.g., c_{slide}) caused by the drive comb fingers 206b sliding through 206a may be approximately computed as:

$${c}_{slide} = μ A β \frac{sinh ( 2 β {d}_{0} ) + sin ( 2 β {d}_{0} )}{cosh ( 2 β {d}_{0} ) - cos ( 2 β {d}_{0} )} , \qquad ( 4 )$$

where μ is viscous coefficient for the air, d₀ is air gap between two comb fingers, A is total overlap area for all drive comb fingers 206a, 206b, and β is a constant defined by:

$$β = \sqrt{\frac{{ω}_{n} ρ}{2 μ}} , \qquad ( 5 )$$

where ωₙ is the natural frequency of the scanning mirror 202 and ρ is air density. The slide damping ratio (ξ_{slide}) for the scanning mirror 202 may be calculated based at least in part on the slide film damping coefficient (c_{slide}) using Equation (6):

$${ξ}_{slide} = \frac{{c}_{slide}}{2 {ω}_{n}} \frac{{a}^{2} + a b + {b}^{2}}{3 \cdot J} , \qquad ( 6 )$$

where a and b are start and end positions of the overlap between drive comb fingers 206a and 206b as defined in FIG. 2A, ωₙ is the natural frequency of the scanning mirror 202. The slide film damping Q-factor (Q_{slide}) for the scanning mirror 202 may be calculated as:

Q_{slide}=1/(2ξ_{slide}) (7).

FIG. 2B illustrates a top view of another exemplary scanning mirror design 201, according to embodiments of the disclosure. Various aspects of the scanning mirror design 201 may be used (e.g., during the design phase) to calculate the squeeze film damping Q-factor (Q_{squeeze}) of a scanning mirror 202 (e.g., MEMS mirror 110).

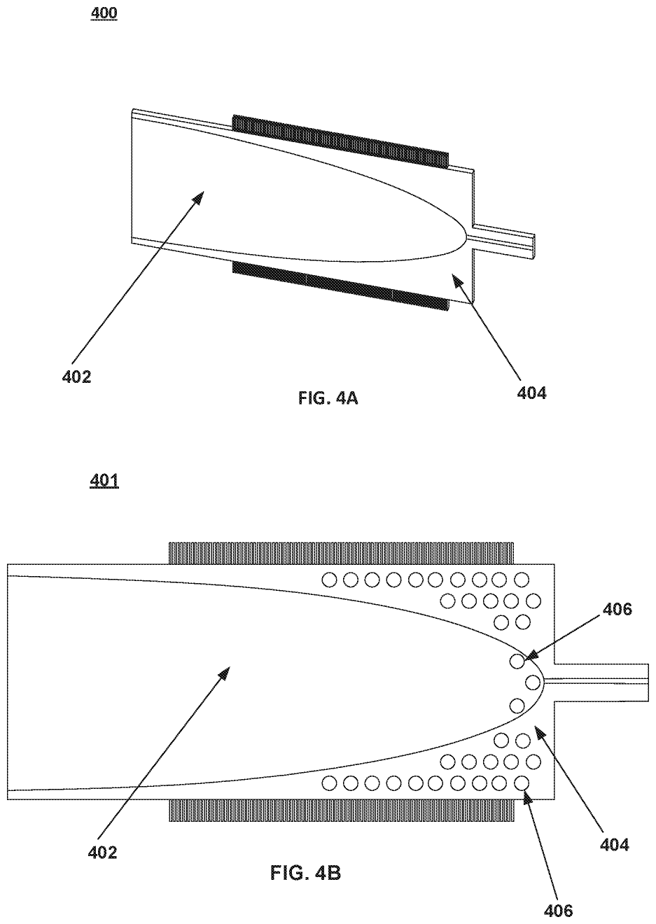

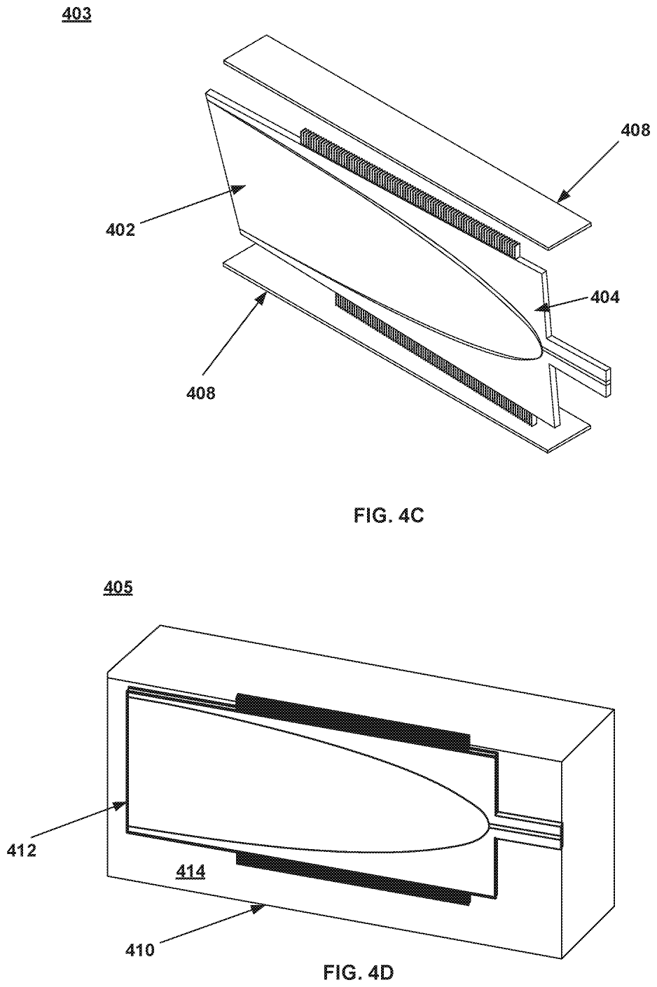

For example, the scanning mirror design 201 may include a second set of design parameters that may be used to compute Q_{squeeze}. In some embodiments, second set of design parameters may be associated with one or more components of the scanning mirror assembly that affect the squeeze film damping of the mirror. While many of those components that affect the slide film damping may also affect squeeze film damping, some may not, such as the fixed drive comb fingers. Therefore, as seen in FIG. 2B, the second set of design parameters associated with scanning mirror design 201 may differ from the first set of design parameters associated with scanning mirror design 200 in FIG. 2A. For example, the one or more components of the scanning mirror assembly that may affect the squeeze film damping Q-factor may include one or more of, but are not limited to, a scanning mirror 202 (e.g., MEMS mirror 110), a gimbal 404 (shown in FIG. 4A), a first set of anchors 204a, a second set of anchors 204b, sliding drive comb fingers 206b coupled to the scanning mirror 202, a torsion spring 208, a substrate 210, holes formed in the scanning mirror (shown in FIG. 4B), air dams formed adjacent to the scanning mirror (shown in FIG. 4C), and/or holes formed in the gimbal (shown in FIG. 4B), just to name a few. Because the squeeze film damping may not be affected by the fixed drive comb fingers (e.g., fixed drive comb fingers 206a seen in FIG. 2A), the second set of design parameters may not include parameters associated with them. Excluding parameters associated with the fixed drive comb fingers 206a, as in the present disclosure, may enable solution convergence in the simulation model since computations are based on a more uniform mesh (e.g., scanning mirror mesh).

In some embodiments, the second set of design parameters may be parameters of these components, and any change to these parameters may affect the squeeze film damping Q-factor. For example, the second set of design parameters may include dimensions (e.g., length, width, and thickness) of above components, e.g., dimensions of the scanning mirror 202. Some other examples of the second set of design parameters may include, e.g., dimensions of one or more of the sliding drive comb fingers 206b, gimbal 404, torsion spring 208, anchors 204a, anchors 204b, just to name a few. Some other examples of the second set of design parameters may include the distance between the scanning mirror 202 and the anchors 204b. Still other examples of the second set of design parameters may include one or more of the materials of these components, the natural frequency of the scanning mirror 202, air density, ambient pressure, operation frequency, silicon density, moment of inertia of the scanning mirror 202, just to name a few. Some embodiments of the second set of design parameters may include, e.g., dimensions and/or positions associated with one or more holes formed in the scanning mirror 202 (shown in FIG. 4B). In some other embodiments, the second set of design parameters may include, e.g., dimensions and/or positions associated with one or more holes 406 formed in a gimbal 404 (shown in FIG. 4B).

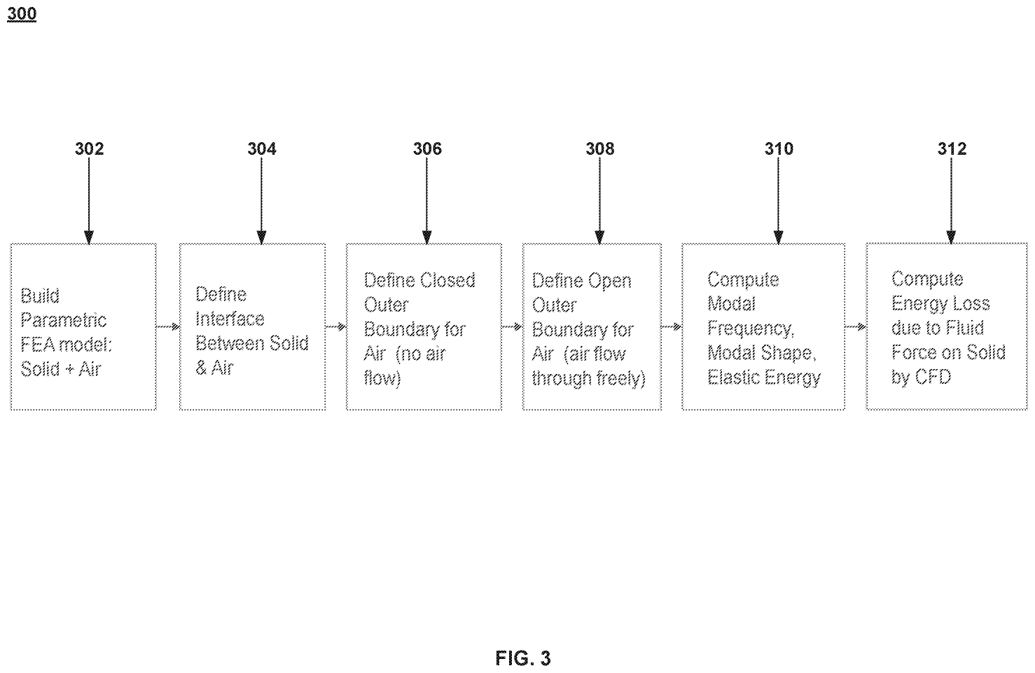

Additional details associated with computing Q_{squeeze} using the second set of parameters associated with the scanning mirror design 201 in FIG. 2B are described below in connection with FIG. 3.

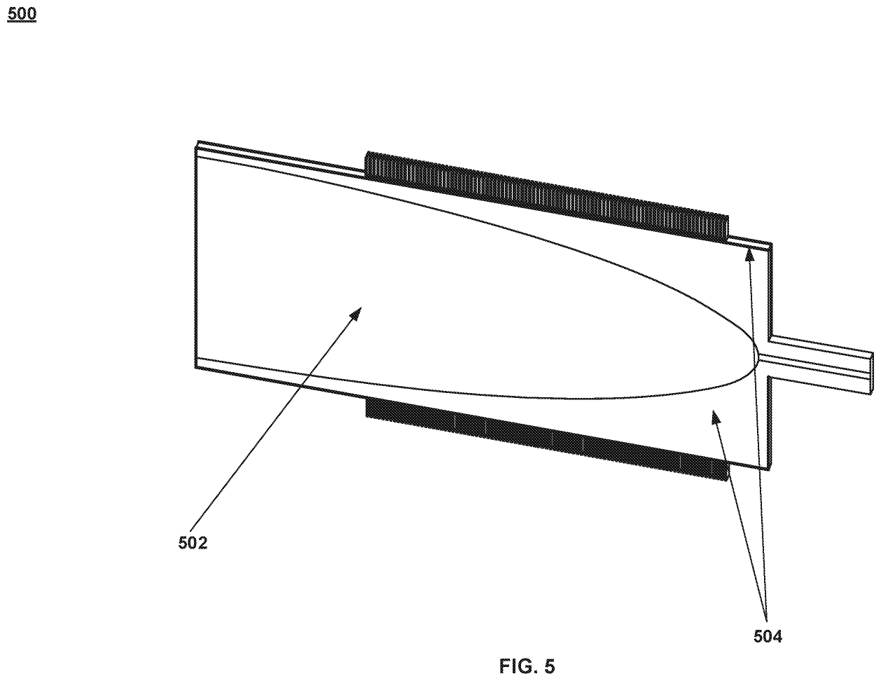

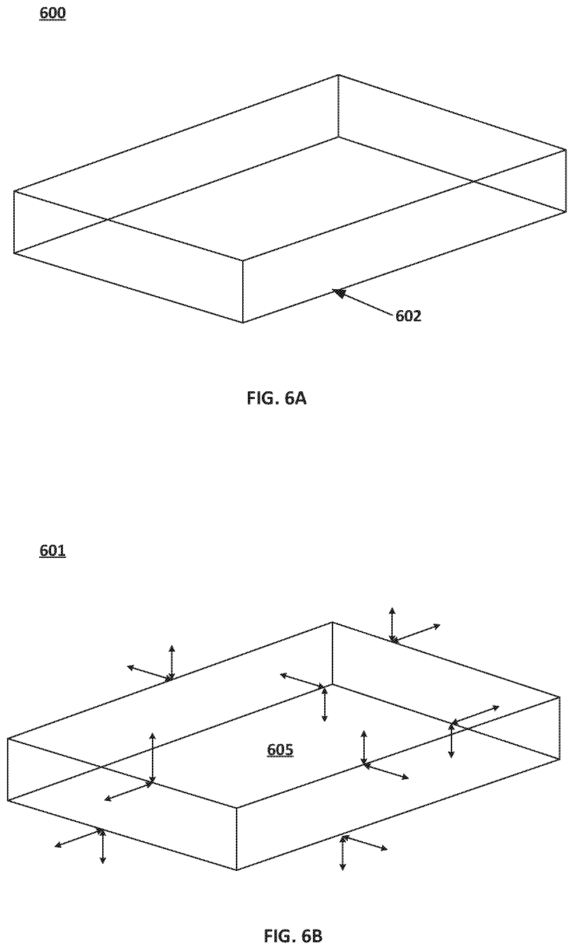

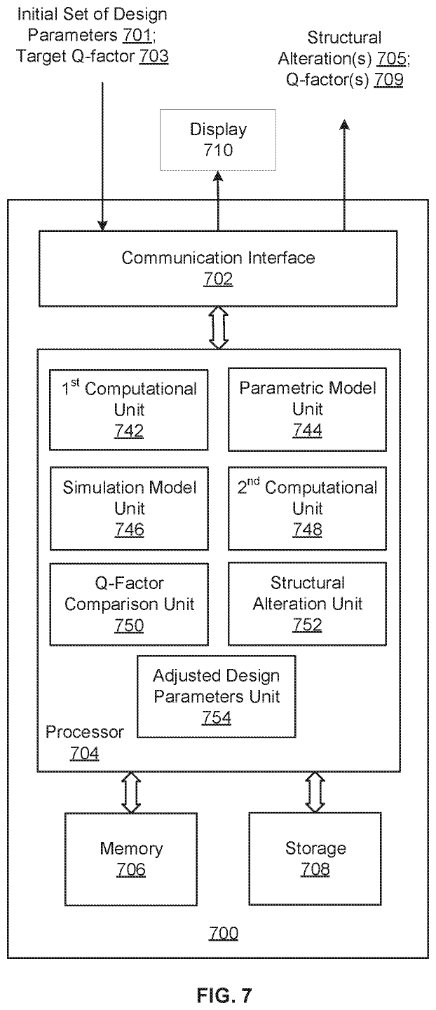

FIG. 3 illustrates a data flow 300 for computing Q_{squeeze} according to embodiments of the disclosure. In some embodiments, the data flow 300 may be associated with a simulation model. The operations of data flow 300 may be performed by at least one processor, e.g., processor 704 illustrated in FIG. 7. The operations of data flow 300 may begin when a set of design parameters (e.g., the second set of design parameters described above in connection with FIG. 2B) are received. Certain operations in the data flow 300 of FIG. 3 are illustrated with additional detail in connection with FIGS. 4A, 4B, 4C, 4D, 5, 6A, and 6B. For example, FIGS. 4A, 4B, and 4C illustrate a first parametric model 400, a second parametric model 401, and a third parametric model 403, respectively, each associated with a different scanning mirror assembly. FIG. 4D illustrates a fourth parametric model 405 associated with air surrounding the scanning mirror assembly associated with the first parametric model 400, the second parametric model 401, or the third parametric model 403, according to embodiments of the disclosure. Each of the first parametric model 401, the second parametric model 402, the third parametric model 403, and the fourth parametric model 404 are illustrated with respect to half of a symmetric, elliptical scanning mirror assembly due to the nature of mirror symmetry in optical sensing systems. The Q-factor(s) (e.g., Q_{slide}, Q_{squeeze}, and Qₜₒₜₐₗ) computed for half of a symmetric (e.g., elliptical or otherwise) scanning mirror assembly may be the same as the entire scanning mirror assembly. However, the parametric models described herein are not limited to half of a scanning mirror assembly. On the contrary, the first parametric model 401, the second parametric model 402, the third parametric model 403, and the fourth parametric model 404 may be generated for a full scanning mirror assembly without departing from the scope of the present disclosure. Furthermore, although the scanning mirror assembly is described below in connection with an elliptical scanning mirror assembly, the shape is not limited thereto. Instead, the parametric models and computations described below in connection with FIGS. 4A-4D may be performed for a scanning mirror assembly with any shape that is either symmetric or asymmetric without departing from the scope of the present disclosure. FIG. 5 illustrates an interface 500 between air and a scanning mirror assembly, according to embodiments of the disclosure. FIGS. 6A and 6B illustrate a closed air boundary 600 where there is no air flow and an open air boundary 601 where air can flow in and out, respectively, according to embodiments of the disclosure. FIGS. 3, 4A, 4B, 4C, 4D, 5, 6A, and 6B will be described together.

Referring to FIG. 3, operations 302, 304, 306, 308, 310 may be used to generate a parametric model (e.g., FEA model) of the scanning mirror and surrounding air. Operation 312 may apply a simulation model (e.g., a CFD model) to the parametric model (e.g., FEA model) to compute information associated with the air flow and energy dissipation of the scanning mirror. In some embodiments, in terms of actual coding, the processor may implement operations 302, 304, 306, 308, 310 with a predetermined script, e.g., such as ANSYS simulation software and/or APDL, which is an ANSYS programming and development language used to generate an FEA model. On the other hand, the at least one processor may implement operation 312 with ANSYS CFX (e.g., a CFD model language). By using scripted modeling before inputting the parameters into the CFD model, operations of data flow 300 allow efficient adjustment of CFD parameters to reflect design changes that may occur during the mirror design phase.

At operation 302, the at least one processor may generate a parametric model associated with a scanning mirror assembly. The parametric model may be generated, e.g., using a set of design parameters that excludes parameters associated with fixed drive comb fingers (e.g., the second set of design parameters of FIG. 2B), and includes either hole(s) formed in the scanning mirror and/or gimbal or air dams located adjacent to the scanning mirror. The parametric model generated at operation 302 may include a structural parametric model (e.g., one of the first parametric model 400, the second parametric model 401, or the third parametric model 403) and an air parametric model (e.g., the fourth parametric model 405) that is related to the structural parametric model.

As illustrated in FIG. 4A, the first parametric model 400 may be associated with the structure of a scanning mirror assembly (e.g., a scanning mirror 402, a gimbal 404, etc.) designed with the second set of design parameters described above in connection with FIG. 2B. In some embodiments, the first parametric model 400 may exclude both air holes and/or air dams.

As illustrated in FIG. 4B, the second parametric model 401 may be associated with the structure of a scanning mirror assembly (e.g., a scanning mirror 402, and gimbal 404, etc.) designed with the second set of design parameters that includes holes 406 for air passage as described above in connection with FIG. 2B. In some embodiments associated with FIG. 4B, the holes 406 may be formed in the scanning mirror 402 and not in the gimbal 404. In some other embodiments associated with FIG. 4B, the holes 406 may be formed in the gimbal 404 and not in the scanning mirror 402. In still other embodiments associated with FIG. 4B, the holes 406 may be formed in both the scanning mirror 402 and the gimbal 404.

Still referring to FIG. 4B, holes 406 may be included in one or more of the scanning mirror 402 or the gimbal 404 in order to increase air flow in the scanning mirror assembly, and, hence, reduce squeeze film damping. In other words, the inclusion of holes 406 in the scanning mirror 202 and/or gimbal 404 may increase the Q-factor (e.g., both Q_{squeeze} and Qₜₒₜₐₗ) associated with the scanning mirror 202. The greater the air flow within the scanning mirror assembly, the larger the Q-factor. Hence, an increase in the number or size of the holes 406 may increase the Q-factor.

Referring to FIG. 4B, in some embodiments, holes 406 included in the gimbal 404 may occupy a certain percentage of the surface area of the gimbal 404. For example, holes 406 formed in the scanning mirror 402 may occupy less than twenty percent of the surface area of the scanning mirror 402. By limiting the holes 406 to less than twenty percent of the surface area, the scanning mirror 402 may maintain a large enough reflective surface to properly reflect light within the optical sensing system. However, in certain embodiments, holes 406 may be formed in more than twenty percent of the surface area of the scanning mirror 402. In some other embodiments, the one or more holes 406 may be included around a perimeter of the scanning mirror 402 in order to avoid degrading the performance of the scanning mirror 402.

In some embodiments, one or more holes 406 may be among the design alterations made to an initial design of scanning mirror 402. For example, the initial design may use a set of initial design parameters and associate with an initial Q-factor. The set of initial design parameters may be modified based on a comparison of the initial Q-factor with a target Q-factor. Based on the comparison, the at least one processor may be configured to output an adjusted scanning mirror design and/or set of adjusted design parameters that is more closely associated with the target Q-factor. In some embodiments, the set of adjusted design parameters of scanning mirror 402 that includes, e.g., hole(s) 406, may be input by the at least one processor at operation 302. Additional details associated with outputting an adjusted set of design parameters for a scanning mirror design is described below, e.g., in connection with FIGS. 7-9.

In some other embodiments, at operation 302, a user may include one or more holes 406 in either the scanning mirror 402 or the gimbal 404 when the set of initial design parameters (e.g., that does not include holes or that includes a fewer number or a smaller size of holes 406) is associated with a Q-factor that is undesirably small. Hence, by including a larger number or a larger size of holes 406 in the set of design parameters, at operation 302, the user may be able to tailor a scanning mirror design with a particular Q-factor for a particular use case. Additional details associated with enabling a user to tailor a scanning mirror design with a particular Q-factor are described below, e.g., in connection with FIGS. 7, 10, and 11.

As illustrated in FIG. 4C, the third parametric model 403 may be associated with a scanning mirror assembly (e.g., scanning mirror 402, gimbal 404, air dams 408, etc.) designed with the second set of design parameters that includes air dams described above in connection with FIG. 2B.

As seen in FIG. 4C, one or more air dams 408 may be included above and/or below the scanning mirror 402/gimbal 404 in order to reduce air flow, and, hence, increase squeeze film damping. In other words, the inclusion of air dams 408 may be used to decrease the Q-factor (e.g., one or more of Q_{slide}, Q_{squeeze}, or Qₜₒₜₐₗ) of the scanning mirror assembly. The less air flow within the scanning mirror assembly, the smaller the Q-factor. Hence, an increase in the length and width of the air dams 408 may reduce the Q-factor associated with the scanning mirror design. Furthermore, a reduction in the distance between the air dams 408 and the scanning mirror 402/gimbal 404 may reduce the Q-factor associated with the scanning mirror assembly.

As seen in FIG. 4C, in some embodiments, a first one of the air dams 408 may be positioned lengthwise along a first side of the scanning mirror 402 and a second one of the air dams 408 may be positioned lengthwise along a second side of the scanning mirror 402. In some other embodiments, the first side and second side are parallel longitudinal sides of the scanning mirror 402. In some other embodiments, a planar surface of the at least one air dam 408 may be orthogonal to a planar surface of the scanning mirror 402, as illustrated in FIG. 4C.

In some embodiments, air dams 408 may be among the design alterations made to an initial design of scanning mirror 402. For example, the initial design may use a set of initial design parameters and associate with an initial Q-factor. The set of initial design parameters may be modified based on a comparison of the initial Q-factor with a target Q-factor. Based on the comparison, the at least one processor may be configured to output an adjusted scanning mirror design and/or set of adjusted design parameters that is more closely associated with the target Q-factor. In some embodiments, the set of adjusted design parameters of scanning mirror 402 that includes, e.g., air dams 408 may be input by the at least one processor at operation 302. Additional details associated with outputting an adjusted set of design parameters for a scanning mirror design is described below, e.g., in connection with FIGS. 7-9.

In some other embodiments, a user may include one or more air dams 408 on either the top and/or bottom of the scanning mirror 402/gimbal 404 when the set of initial design parameters (e.g., that does not include air dams or that includes air dams that are improperly sized or positioned) is associated with a Q-factor that is undesirably large. Hence, by including air dams 408 or adjusting the size and/or position of the air dams 408, the user may be able to tailor a scanning mirror design with a desired Q-factor.

As illustrated in the embodiment shown in FIG. 4C, the air dams 408 may include two parallel walls, which may be positioned at any distance from the scanning mirror 402 and gimbal 404 depending on the target Q-factor. However, the air dams 408 are not limited to the planar and continuous walls illustrated in FIG. 4C.

In still other embodiments, the air dams 408 may be non-planar in shape. For example, the air dams 408 may have a wavy shape with peaks and valleys located at different distances from the scanning mirror assembly. Here, the peaks may be located at a first distance from the scanning mirror assembly, and the valleys may be located at a second distance that is less than the first distance. The additional distance from the scanning mirror assembly to the peaks may increase air flow within the system as compared to a system with planar air dams. Hence, when an initial Q-factor associated with planar air dams 408 is smaller than the target Q-factor, the air dams 408 may be redesigned with a non-planar shape to increase the Q-factor.

In certain other embodiments, for example, the air dams 408 (e.g., either planar or non-planar) may be designed with one or more holes/slots through which air may flow. Holes/slots may be included in the air dams 408 to increase the Q-factor of the scanning mirror assembly. For example, when an initial Q-factor associated with air dams 408 with a continuous surface is smaller than the target Q-factor, the air dams 408 may be redesigned with holes to increase the Q-factor. The holes may be circular or elliptical in shape, while slots may be rectangular in shape.

Additionally and/or alternatively, the length of the air dams 408 is not limited to the length of the scanning mirror assembly. For example, in certain embodiments, the length of the air dams 408 may be shorter than the length of the scanning mirror assembly. In certain other embodiments, the air dams 408 (e.g., planar, non-planar, continuous surface, non-continuous surface with holes, etc.) may be formed along the entire length of the scanning mirror assembly as well as along at least a portion of the width of the assembly. Here, the air dams 408 may be unitary with an “L-shape.” Additional details associated with enabling a user to tailor a scanning mirror design with a particular Q-factor are described below, e.g., in connection with FIGS. 7, 10, and 11.

As illustrated in FIG. 4D, the fourth parametric model 405 may include a block 410 filled with air 412 with negative space 414 around the absent structure of scanning mirror assembly generated in the first parametric model 400. In embodiments in which the structural parametric model includes holes (e.g., such as in the second parametric model 401 of FIG. 4B), the fourth parametric model 405 may include air 412 filled into the space created by the holes 406. In embodiments in which the structural parametric model includes air dams (e.g., such as the third parametric model 403 of FIG. 4C), the fourth parametric model 405 may include an additional negative space around the absent structure of the air dams.

At operation 304, the at least one processor may extract the interface between the solid structures of the scanning mirror assembly (e.g., scanning mirror 402, gimbal 404, air holes 406, air dams 408, etc.) and the air.

As illustrated in FIG. 5, the interface 500 extracted may include all moving surfaces 502 for scanning mirror along all surfaces 504 for other components of the scanning mirror assembly, e.g., such as the gimbal, drive comb, torsion spring, just to name a few.

At operation 306, the at least one processor may define all the air outer surfaces where there is no air flow, e.g., against a solid wall. For example, the air enclosure 602 in FIG. 6A illustrates air outer surfaces where the at least one processor may define with no air flow.

At operation 308, the at least one processor may define all the air outer surfaces where the air is free to flow in and/or out. For example, the air enclosure 605 in FIG. 6B includes all outer surfaces where the air is exposed to ambient pressure and is free to flow in and/or out.

At operation 310, the at least one processor may compute modal shape and modal frequencies of various portions of the scanning mirror based at least in part on information obtained by the at least one processor by performing operations 302, 304, 306, 308. At operation 310, the at least one processor may compute total elastic energy (E) for the scanning mirror structure at the deformed shape for a specific frequency at which the scanning mirror operates. The at least one processor may generate a parametric model (e.g., FEA model) by performing operations 302, 304, 306, 308, and 310.

At operation 312, the at least one processor may apply a simulation model (e.g., CFD model) to the parametric model output by operation 310 (e.g., FEA model) to compute energy loss (ΔE) due to the force of air on the scanning mirror assembly over one period of harmonic oscillation. The simulation model may, among other things, treat air as the fluid being simulated, impose the modal harmonic motion on the inner air interfaces, apply boundary conditions on both closed and open surfaces, and specify integration parameters (e.g., step size, how many periods to simulate, etc.) in order to determine the scanning mirror's energy loss (ΔE) over one period.

Once the total energy (E) and the energy loss (ΔE) have been determined by applying the CFD model, the at least one processor may compute the squeeze damping ratio (ξ_{squeeze}) using Equation (8):

$${ξ}_{squeeze} = \frac{Δ E}{4 π E} . \qquad ( 8 )$$

The at least one processor may compute the squeeze film damping Q-factor (Q_{squeeze}) using Equation (9):

Q_{squeeze}=1/(2ξ_{squeeze}) (9).

Using the ξ_{slide} and ξ_{squeeze} computed above using Equations (6) and (8) respectively, the at least one processor may compute the total damping ratio (ξₜₒₜₐₗ) of the scanning mirror as:

ξₜₒₜₐₗ=ξ_{squeeze}+ξ_{slide} (10).

Using the Q_{slide} and Q_{squeeze} computed above using Equations (7) and (9) respectively, the at least one processor may compute the total damping ratio (Qₜₒₜₐₗ) for the scanning mirror as:

$${Q}_{total} = \frac{{Q}_{squeeze} \cdot {Q}_{slide}}{{Q}_{squeeze} + {Q}_{slide}} . \qquad ( 11 )$$

FIG. 7 illustrates a block diagram of an exemplary system 700 for designing a scanning mirror (e.g., MEMS mirror 110 of FIG. 1), according to embodiments of the disclosure. In some embodiments, as shown in FIG. 7, system 700 may include a communication interface 702, a processor 704, a memory 706, and a storage 708. In some embodiments, system 700 may have different modules in a single device, such as an integrated circuit (IC) chip (e.g., implemented as an application-specific integrated circuit (ASIC) or a field-programmable gate array (FPGA)), or separate devices with dedicated functions. In some embodiments, one or more components of system 700 may be located in a cloud or may be alternatively in a single location (such as inside a mobile device) or distributed locations. Components of system 700 may be in an integrated device or distributed at different locations but communicate with each other through a network (not shown). Consistent with the present disclosure, system 700 may be configured to determine the design parameter values of the scanning mirror.

Communication interface 702 may send data to and receive data from databases via communication cables, a Wireless Local Area Network (WLAN), a Wide Area Network (WAN), wireless networks such as radio waves, a cellular network, and/or a local or short-range wireless network (e.g., Bluetooth™), or other communication methods. In some embodiments, communication interface 702 may include an integrated service digital network (ISDN) card, cable modem, satellite modem, or a modem to provide a data communication connection. As another example, communication interface 702 may include a local area network (LAN) card to provide a data communication connection to a compatible LAN. Wireless links can also be implemented by communication interface 702. In such an implementation, communication interface 702 can send and receive electrical, electromagnetic or optical signals that carry digital data streams representing various types of information.

Consistent with some embodiments, communication interface 702 may receive a first set of design parameters and a second set of design parameters of the scanning mirror from a database or a user input (not shown). Communication interface 702 may further provide the received data to memory 706 and/or storage 708 for storage or to processor 704 for processing.

Processor 704 may include any appropriate type of general-purpose or special-purpose microprocessor, digital signal processor, or microcontroller. Processor 704 may be configured as a separate processor module dedicated to determining design parameter values of the scanning mirror and making design changes of the scanning mirror based on the design parameter values. Alternatively, processor 704 may be configured as a shared processor module for performing other functions in addition to determining design parameter values and making design changes of the scanning mirror.

Memory 706 and storage 708 may include any appropriate type of mass storage provided to store any type of information that processor 704 may need to operate. Memory 706 and storage 708 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 706 and/or storage 708 may be configured to store one or more computer programs that may be executed by processor 704 to perform functions disclosed herein. For example, memory 706 and/or storage 708 may be configured to store program(s) that may be executed by processor 704 to determine design parameter values of the scanning mirror.

In some embodiments, memory 706 and/or storage 708 may also store various scanning mirror design parameters including e.g., initial design parameters and adjusted design parameters associated with structural alterations (e.g., holes, air dams, etc.), target Q-factors for various scanning mirror designs, a look-up table that correlates structural alterations with a Q-factor or a difference between an initial Q-factor and a target Q-factor (e.g., ΔQ), parametric models, FEA models, and/or CFD models, etc. Memory 706 and/or storage 708 may also store information associated with Equations (4)-(11) used to compute damping coefficients, damping ratios, and/or Q-factors, etc.

As shown in FIG. 7, processor 704 may include multiple modules, such as a first computational unit 742, a parametric model unit 744, a simulation model unit 746, a second computational unit 748, a Q-factor comparison unit 750, a structural alteration unit 752, an adjusted design parameters unit 754 and the like. These modules (and any corresponding sub-modules or sub-units) can be hardware units (e.g., portions of an integrated circuit) of processor 704 designed for use with other components or software units implemented by processor 704 through executing at least part of a program. The program may be stored on a computer-readable medium, and when executed by processor 704, it may perform one or more functions. Although FIG. 7 shows units 742-754 all within one processor 704, it is contemplated that these units may be distributed among different processors located closely or remotely with each other. For example, units 742, 744, 748 may be part of an optimization device, unit 746 may be part of a separate simulation device, and units 750-754 may be part of a design parameter generation device. Additionally, unit 744 may be part of an optimization device while unit 746 may be part of a separate simulation device, and units 742 and 748 may be part of a computational device. In certain implementations, one or more of units 742-754 may be omitted, depending on the specific design task.

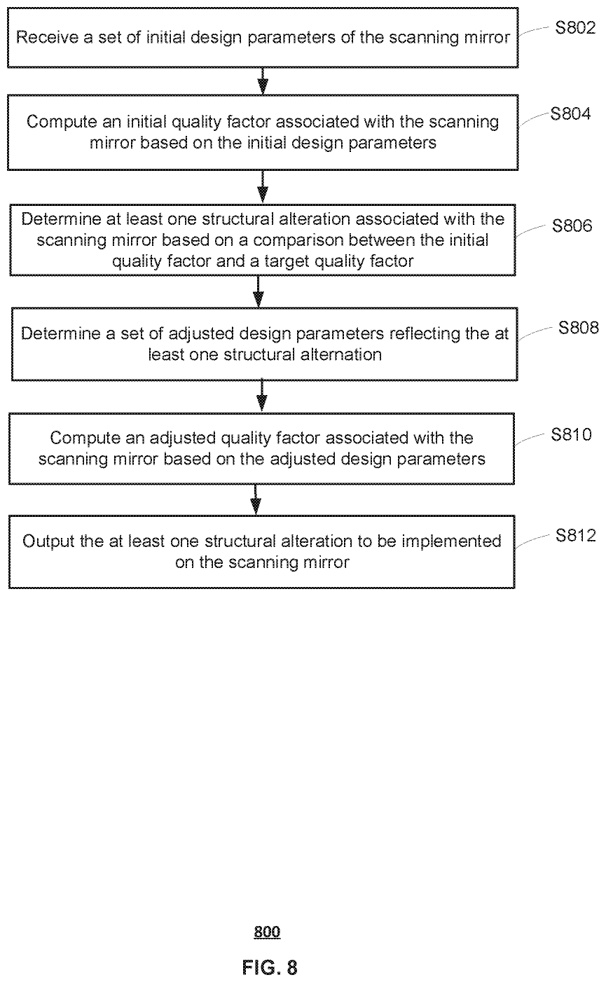

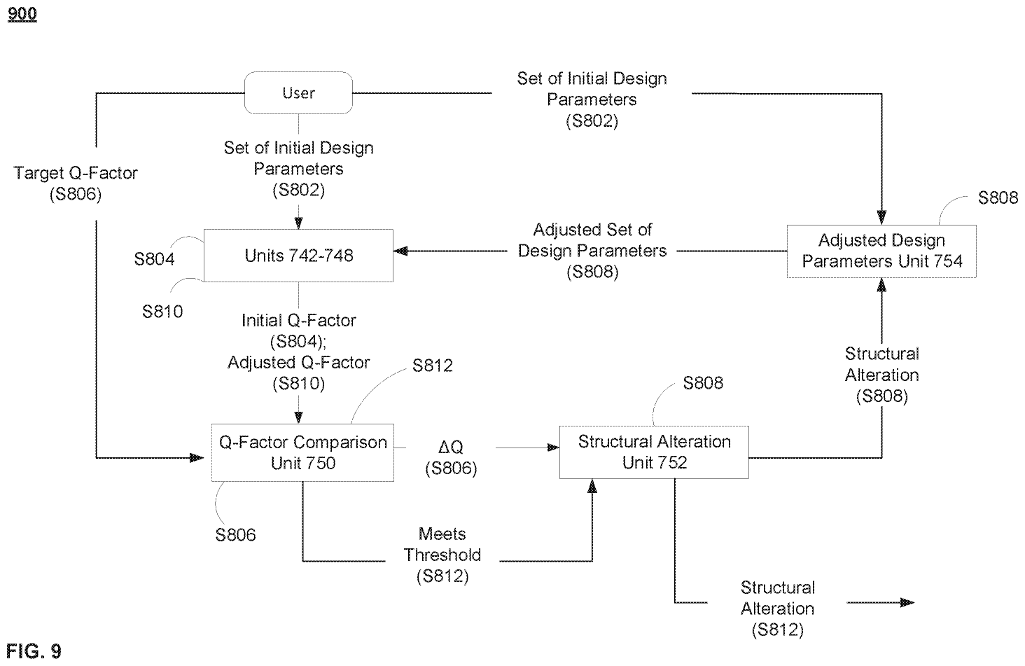

In some embodiments, one or more of units 742-754 of FIG. 7 may execute first computer instructions to design a scanning mirror. FIG. 8 illustrates a flowchart of an exemplary method 800 for designing scanning mirrors, according to embodiments of the disclosure. Method 800 may be performed by system 700 and particularly processor 704 or a separate processor not shown in FIG. 7. Method 800 may include steps S802-S812 as described below. It is to be appreciated that some of the steps may be optional, and some of the steps may be performed simultaneously, or in a different order than shown in FIG. 8. FIG. 9 illustrates a data flow diagram 900 of an exemplary system for designing scanning mirrors, according to embodiments of the disclosure. FIGS. 7-9 will be described together below.

In step 802, communication interface 702 may receive a set of initial design parameters 701 (e.g., including the first and second set of design parameters associated with scanning mirror design 200, 201 of FIGS. 2A and 2B) of the scanning mirror. In some embodiments, the second set of design parameters may exclude parameters associated with the fixed drive comb fingers that may be included in the first set of design parameters.

In step 804, the first computational unit 742, the parametric model unit 744, the simulation model unit 746, and the second computational unit 748 may compute an initial quality factor associated with the scanning mirror based on the set of initial design parameters 701. In some embodiments, the first computational unit 742, the parametric model unit 744, the simulation model unit 746, and the second computational unit 748 may compute the initial quality factor using the techniques described above in connection with FIGS. 2A-6B.

For example, in some embodiments of step 804, first computational unit 742 may compute a first quality factor (e.g., Q_{slide}) associated with slide film damping of the scanning mirror based on a first subset of initial design parameters 701 that impact the slide film damping. In some embodiments, the first computational unit 742 may compute Q_{slide} by applying a first set of computations (e.g., Equations (4)-(7) described above) to the subset of initial design parameters 701.

In some embodiments of step 804, the first computational unit 742 may compute Q_{slide} by computing a first damping coefficient (c_{slide}) based on the first subset of the initial design parameters and a first formula. The first formula may include one or more of Equations (4) and/or (5) described above in connection with FIG. 2A. The first computational unit 742 may compute a first damping ratio (ξ_{slide}) based on the first damping coefficient (c_{slide}) and a second formula. The second formula may include at least in part Equation (6) described above in connection with FIG. 2B. Furthermore, the first computational unit 742 may compute Q_{slide} based at least in part on ξ_{slide} and Equation (7) described above in connection with FIG. 2A.

In some embodiments of step 804, the parametric model unit 744 and the simulation model unit 746 may compute a second quality factor (e.g., Q_{squeeze}) associated with squeeze film damping of the scanning mirror based on a second subset of the initial design parameters that impact the squeeze film damping. For example, the parametric model unit 744 may generate a parametric model of the scanning mirror and surrounding air based at least in part on the second set of design parameters. The parametric model unit 744 may compute modal information using the parametric model. One or more of the parametric model and/or the modal information may be sent to the simulation model unit 746.

In some embodiments of step 804, the simulation model unit 746 may compute Q_{squeeze} based at least in part on the parametric model and modal information received from the parametric model unit 744 based on a simulation model. The simulation model may include, for example, a CFD model.

In some embodiments of step 804, the simulation model unit 746 may compute the energy loss (ΔE) over one period by applying a simulation model (e.g., CFD model) to one or more of the parametric model or modal information. In some embodiments, the simulation model unit 746 may compute a second damping ratio (ξ_{squeeze}) based at least in part on the energy loss (ΔE) over one period and a third formula. For example, the third formula may include at least in part Equation (8) described above in connection with FIG. 3. In some embodiments, simulation model unit 746 may compute Q_{squeeze} based at least in part on ξ_{squeeze} and a fourth formula. For example, the fourth formula may include at least in part Equation (9) described above in connection with FIG. 3.

In some embodiments of step 804, the second computational unit 748 may compute a third quality factor (e.g., Qₜₒₜₐₗ) associated with the scanning mirror based on the first quality factor (e.g., Q_{slide}) and the second quality factor (e.g., Q_{squeeze}). In some embodiments, the second computational unit 748 may compute Qₜₒₜₐₗ based at least in part on a fifth formula, Q_{slide}, and Q_{squeeze}. For example, the fifth formula may include at least in part Equation (11) described above in connection with FIG. 3.

In some alternative embodiments of step 804, the second computational unit 748 may compute a third damping ratio (e.g., ξₜₒₜₐₗ) associated with the scanning mirror based on the first damping ratio (e.g., ξ_{slide}), the second damping ratio (e.g., ξ_{squeeze}), and a sixth formula. For example, the sixth formula may include at least in part Equation (10) described above in connection with FIG. 3.

In some embodiments of step 804, the second computational unit 748 may output the third quality factor 709 associated with the scanning mirror to the communication interface 702. The communication interface 702 may output the third quality factor 709.

In step 806, the Q-factor comparison unit 750 may compare the initial quality factor (e.g., Qₜₒₜₐₗ associated with the set of initial design parameters 701) and a target quality factor 703 (e.g., input into the communication interface 702) and the structural alteration unit 752 may determine at least one structural alteration associated with the scanning mirror based on the comparison. For example, Q-factor comparison unit 750 may determine a different between the two quality factors (ΔQ). A signal associated with ΔQ may be sent to the structural alteration unit 752.

The structural alteration unit 752 may access, e.g., a look-up table maintained in the memory 706 and/or storage 708. In some embodiments, the look-up table may include correlations of different ΔQs and corresponding types of structural alterations. For example, when ΔQ indicates that the initial quality factor is smaller than the target quality factor 703, the at least one structural alteration indicated by the look-up table may include at least one hole formed in one or more of a gimbal of the scanning mirror or a mirrored surface of the scanning mirror. In certain other examples, when ΔQ indicates that the initial quality factor is larger than the target quality factor, the at least one structural alteration indicated in the look-up table may include at least one air dam configured to increase damping associated with the scanning mirror. A signal indicating the at least one structural alteration may be sent to the adjusted design parameters unit 754.

At step 808, the adjusted design parameters unit 754 may determine a set of adjusted design parameters reflecting the at least one structural alternation. The adjusted design parameters may be determined based at least in part on the at least one structural alteration and the set of initial design parameters 701. For example, when the at least one structural alteration includes a set of holes of a predetermined size, position, and/or location on the scanning mirror and/or gimbal, the adjusted set of design parameters may include the set of holes on the set of initial design parameters 701. Alternatively, when the at least one structural alteration includes an air dam positioned above and below the scanning mirror/gimbal, the adjusted set of design parameters may include the air dams above and below the scanning mirror/gimbal in the set of initial design parameters 701. Information associated with the adjusted set of design parameters may be sent to the first computational unit 742, the parametric model unit 744, the simulation model unit 746, and the second computational unit 748.

In step 810, the first computational unit 742, the parametric model unit 744, the simulation model unit 746, and the second computational unit 748 may compute an adjusted quality factor associated with the scanning mirror based on the adjusted design parameters. In some embodiments, the first computational unit 742, the parametric model unit 744, the simulation model unit 746, and the second computational unit 748 may compute the adjusted quality factor similarly to step S804 using the techniques described above in connection with FIGS. 2A-6B. Information associated with the adjusted quality factor may be sent to the Q-factor comparison unit 750.

In step 812, one or more of the Q-factor comparison unit 750, the structural alterations unit 752, and/or the communication interface 702 may output the at least one structural alteration when a difference between the adjusted quality factor and the target quality factor is smaller than a predetermined threshold. For example, the Q-factor comparison unit 750 may determine whether a difference between the target quality factor 703 and the adjusted Q-factor are within a predetermined threshold. Upon determining that the difference is within the predetermined threshold, a signal may be sent instructing the structural alterations unit 752 to output the structural alterations. The structural alterations unit 752 may output information associated with the structural alterations 705 to the communication interface 702 or to another component.

In some embodiments, a Q-factor 707 (e.g. Q_{slide}, Q_{squeeze}, and/or Qₜₒₜₐₗ) may be output by the first computational unit 742, the parametric model unit 744, the simulation model unit 746, and the second computational unit 748. The Q-factor 707 may be computed based on the set of initial design parameters 701 and/or the adjusted set of design parameters.

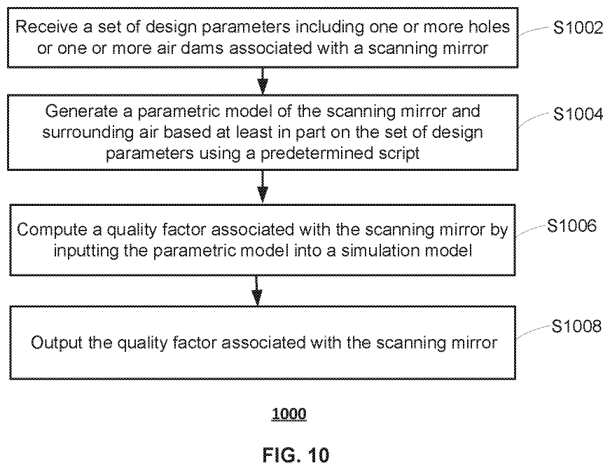

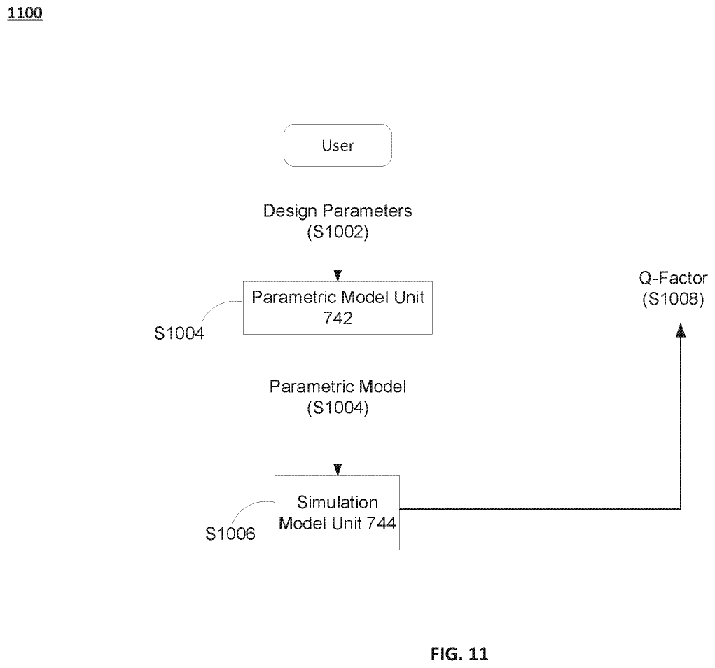

In some embodiments, unit 746 of FIG. 7 may execute second computer instructions to compute a squeeze film damping Q-factor of a scanning mirror design based on the set of initial design parameters or adjusted design parameters. For example, FIG. 10 illustrates a flowchart of another exemplary method 1000 for computing the squeeze film damping Q-factor of an adjusted scanning mirror design, according to embodiments of the disclosure. Method 1000 may be performed by system 700 and particularly processor 704 or a separate processor not shown in FIG. 7. Method 1000 may be performed to implement step S810 of method 800. Method 1000 may include steps S1002-S1008 as described below. It is to be appreciated that some of the steps may be optional, and some of the steps may be performed simultaneously, or in a different order than shown in FIG. 10. FIG. 11 illustrates a data flow diagram 1100 of an exemplary system for designing scanning mirrors, according to embodiments of the disclosure. FIGS. 7, 10, and 11 will be described together below.

In step S1002, communication interface 702 may receive a set of design parameters (e.g., the second subset of the adjusted design parameters associated with scanning mirror design 201 of FIG. 2B) of the scanning mirror. In some embodiments, the second subset of design parameters may exclude parameters associated with the fixed drive comb fingers that may be included in the first subset of design parameters. In certain embodiments, the second subset of design parameters may include the design alterations determined in step S806 of method 800, e.g., one or more holes in either the scanning mirror and/or gimbal. In certain other embodiments, the second subset of design parameters may include one or more air dams positioned adjacent to the scanning mirror. In certain alternative embodiments, the processor 704 may remove any design parameters associated with fixed drive comb fingers from the set of adjusted design parameters to obtain the second subset of design parameters.

In step S1004, the parametric model unit 744 may generate a parametric model of the scanning mirror and surrounding air based at least in part on the set of design parameters using a predetermined script. For example, the parametric model unit 744 may use a predetermined script, e.g., such as ANSYS simulation software and/or APDL, which is an ANSYS programming and development language to generate an FEA model. The parametric model unit may generate the parametric model of the scanning mirror and surrounding air based at least in part on implementing one or more of operations 302-310 described above in connection with FIG. 3.

In some embodiments, the parametric model unit 744 may generate a parametric model of the scanning mirror and surrounding air by defining an interface between the scanning mirror and the surrounding air and at least one outer boundary for the surrounding air, e.g., as described above in connection with operations 304-308 in FIG. 3.

In some embodiments, the parametric model unit 744 may generate a parametric model of the scanning mirror and surrounding air by computing at least one parameter associated with the parametric model based on the defined interface and at least one outer boundary, e.g., as described above in connection with operation 310 in FIG. 3.

In step S1006, the simulation model unit 746 may compute a Q-factor 707 associated with the scanning mirror by inputting the parametric model and modal information (e.g., the computed parameters) into a simulation model. In some embodiments, the simulation model unit 746 may compute the energy loss (ΔE) over one period by applying a CFD model to one or more of the parametric model or modal information. In some embodiments, the simulation model unit 746 may compute a second damping ratio (ξ_{squeeze}) based at least in part on the energy loss (ΔE) over one period and a third formula. For example, the third formula may include at least in part Equation (8) described above in connection with FIG. 3. In some embodiments, simulation model unit 746 may compute Q_{squeeze} based at least in part on ξ_{squeeze} and a fourth formula. For example, the fourth formula may include at least in part Equation (9) described above in connection with FIG. 3.

In step 1008, the simulation model unit 746 may output the quality factor (Q_{squeeze}) associated with the adjusted scanning mirror design. In some embodiments, the simulation model unit 746 may output the Q_{squeeze} to the second computational unit 748. In some alternative embodiments, the simulation model unit 746 may output Q_{squeeze} to the communications interface 702.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A method for designing a scanning mirror for an optical sensing system, comprising:
receiving, by a communication interface, a set of initial design parameters of the scanning mirror;
computing an initial quality factor associated with the scanning mirror, by at least one processor, based on the set of initial design parameters;
determining, by the at least one processor, at least one structural alteration associated with the scanning mirror based on a comparison between the initial quality factor and a target quality factor; and
outputting, by the at least one processor, the at least one structural alteration to be implemented on the scanning mirror.

2. The method of claim 1, wherein the initial quality factor is smaller than the target quality factor, wherein the at least one structural alteration includes at least one hole formed in one or more of a gimbal of the scanning mirror or a mirrored surface of the scanning mirror, and wherein the at least one hole is configured to reduce damping associated with the scanning mirror.

3. The method of claim 2, wherein when the at least one hole is formed in the mirrored surface of the scanning mirror, the at least one hole is formed in less than or equal to twenty percent of a total surface area of the mirrored surface.

4. The method of claim 1, wherein the initial quality factor is larger than the target quality factor, wherein the at least one structural alteration includes at least one air dam configured to increase damping associated with the scanning mirror.

5. The method of claim 4, wherein:
the at least one air dam includes two air dams, and
the two air dams are each planar and continuous, non-planar and continuous, planar and non-continuous, or non-planar and non-continuous.

6. The method of claim 5, wherein a first one of the air dams is positioned lengthwise along a first side of the scanning mirror and a second one of the air dams is positioned lengthwise along a second side of the scanning mirror.

7. The method of claim 6, wherein the first side and second side are parallel longitudinal sides of the scanning mirror.

8. The method of claim 4, wherein a planar surface of the at least one air dam is orthogonal to a planar surface of the scanning mirror.

9. The method of claim 1, further comprising:
determining a set of adjusted design parameters reflecting the at least one structural alteration;
computing an adjusted quality factor associated with the scanning mirror based on the adjusted design parameters; and
outputting the at least one structural alteration when a difference between the adjusted quality factor and the target quality factor is smaller than a predetermined threshold.

10. The method of claim 1, wherein the initial design parameters include a first set of design parameters and a second set of design parameters, and wherein the computing the initial quality factor associated with the scanning mirror further comprises:
computing a first quality factor associated with slide film damping of the scanning mirror, by at least one processor, based on the first set of design parameters;
computing a second quality factor associated with squeeze film damping of the scanning mirror, by the at least one processor, based on the second set of design parameters using a simulation model;
computing a third quality factor associated with the scanning mirror, by the at least one processor, based on the first quality factor and the second quality factor; and
outputting, by the at least one processor, the third quality factor associated with the scanning mirror.

11. A design system for an optical sensing system, comprising:
a communication interface configured to receive a set of initial design parameters of a scanning mirror; and
at least one processor, configured to:
compute an initial quality factor associated with the scanning mirror based on the initial design parameters;
determine at least one structural alteration associated with the scanning mirror based on a comparison between the initial quality factor and a target quality factor; and
output the at least one structural alteration to be implemented on the scanning mirror.

12. The design system of claim 11, wherein the initial quality factor is smaller than the target quality factor, wherein the at least one structural alteration includes at least one hole formed in one or more of a gimbal of the scanning mirror or a mirrored surface of the scanning mirror, and wherein the at least one hole is configured to reduce damping associated with the scanning mirror.

13. The design system of claim 12, wherein when the at least one hole is formed in the mirrored surface of the scanning mirror, the at least one hole is formed in less than or equal to ten percent of a total surface area of the mirrored surface.

14. The design system of claim 11, wherein the initial quality factor is larger than the target quality factor, wherein the at least one structural alteration includes at least one air dam configured to increase damping associated with the scanning mirror.

15. The design system of claim 14, wherein:
the at least one air dam includes two air dams, and
the two air dams are each planar and continuous, non-planar and continuous, planar and non-continuous, or non-planar and non-continuous.

16. The design system of claim 15, wherein a first one of the two air dams is positioned lengthwise along a first side of the scanning mirror and a second one of the two air dams is positioned lengthwise along a second side of the scanning mirror.

17. The design system of claim 16, wherein the first side and second side are parallel longitudinal sides of the scanning mirror.

18. The design system of claim 14, wherein a planar surface of the at least one air dam is orthogonal to a planar surface of the scanning mirror.

19. The design system of claim 11, wherein the at least one processor is further configured to:
determine a set of adjusted design parameters reflecting the at least one structural alteration;
compute an adjusted quality factor associated with the scanning mirror based on the adjusted design parameters; and
output the at least one structural alteration when a difference between the adjusted quality factor and the target quality factor is smaller than a predetermined threshold.

20. A non-transitory computer-readable medium having stored thereon computer instructions, when executed by at least one processor, configured to perform a design method for a scanning mirror of an optical sensing system, the design method comprising:
receiving a set of initial design parameters of the scanning mirror;
computing an initial quality factor associated with the scanning mirror based on the initial design parameters;
determining at least one structural alteration associated with the scanning mirror based on a comparison between the initial quality factor and a target quality factor; and
outputting the at least one structural alteration to be implemented on the scanning mirror.
